(19) United States
(12) Patent Application Publication
(10) Pub. No.: US 2014/0339892 A1
(43) Pub. Date: Nov. 20, 2014

(54) DISCONNECTION UNIT FOR DISCONNECTING A BATTERY FROM A POWER SYSTEM AND A MOTOR VEHICLE HAVING A LITHIUM-ION BATTERY

(71) Applicants: Robert Bosch GmbH, Stuttgart (DE); Samsung SDI Co., Ltd., Yongin-si, Gyeonggi-do (KR)

(72) Inventors: Boris Gendlin, Filderstadt (DE); Stefan Soboll, Dachau (DE); Lars Huebner, Boblingen (DE); Johannes Helmich, Karlsruhe (DE)

(21) Appl. No.: 14/366,720

(22) PCT Filed: Nov. 15, 2012
(86) PCT No.: PCT/EP2012/072661

§ 371 Date: Jun. 19, 2014

(30) Foreign Application Priority Data
Dec. 23, 2011 (DE) 10 2011 089 817.4

(51) Int. Cl. H01H 89/00; H01M 10/0525; H01M 2/34

(52) U.S. Cl. CPC H01H 89/00; H01M 2/348; H01M 10/0525; H01H 2231/026
USPC 307/10.1; 337/4; 429/61

(57) ABSTRACT

A disconnection unit is configured for disconnecting a battery from a power system. A fuse is configured to interrupt a circuit between the battery and the power system. The fuse is integrated into the disconnection unit.

The present invention relates to a disconnection unit for disconnecting a battery from a power system. The invention further relates to a battery, and also to a motor vehicle having the battery.

### PRIOR ART

It is becoming apparent that, in the future, rechargeable batteries on which very stringent requirements are placed in respect of reliability, safety, power-carrying capacity and service life will increasingly be used both in static applications (for example in wind power plants), in motor vehicles (for example in hybrid and electric motor vehicles) and also in the field of consumer goods (for example laptops or mobile telephones).

The background to this requirement is the safety shut-off of the battery in hybrid and electric vehicles. Emergency shut-off may be required, for example, in the event of system-related faults (short circuit) or in the event of accidents. Disconnecting the battery from the power system is intended to prevent fires in the vehicle which are caused due to an accident or short circuit. There are various methods for disconnecting the battery if required. Firstly, the battery can be disconnected by means of a battery switch. This method is not particularly complex in respect of circuitry, but monitoring the operating states and the associated switching on and switching off processes of the switch mean considerably more work for the driver. Secondly, there is the battery disconnection unit which interrupts the flow of current in the battery in the event of an accident or short circuit such that the electric motor is bypassed.

The battery disconnection unit serves to disconnect the electrical circuit of the battery. There are various classes of battery disconnection unit which provide, for example, a connection for the inverter or for various charging plugs. A service disconnector is also provided as standard. This service disconnector constitutes a jumper which has to be pulled so that high-voltage components can be operated. This service disconnector is likewise available with an integrated high-voltage fuse. In addition, the alternative is to interrupt the supply of power to the battery and therefore also the battery disconnection unit by means of a low-voltage service disconnector. The battery disconnection unit returns to its default setting, that is to say the battery is disconnected from the vehicle, as a result. Meeting the requirements for a safe vehicle battery only with the low-voltage service disconnector would on the one hand make the high-voltage fuse in the battery cable harness superfluous, but on the other hand would result in additional outlay on construction and therefore also higher costs.

DE 10 2009 011 261 discloses a high-voltage vehicle interference detection method and an apparatus for this. The method involves detecting high-voltage interference, such as welded switching contactors or disconnected components in a vehicle for example, by measuring the total electrical impedance between the positive and the negative rail of a high-voltage bus and a ground or a chassis, comparing the impedance before and after the switching contactor is opened, and performing a servicing response.

### DISCLOSURE OF THE INVENTION

According to the invention, a disconnection unit for disconnecting a battery from a power system, often also called an on-board vehicle power system, is provided, wherein a fuse is also provided, said fuse serving to interrupt an electrical circuit between the battery and the power system. It is characterized by the fact that the fuse is integrated into the disconnection unit.

The battery is disconnected from a power system, wherein the power system is made up of all of the electrical components in a motor vehicle. According to the embodiment of the invention, the fuse is an integral constituent part of the disconnection unit. In other words, the fuse therefore must not be additionally connected to the disconnection unit as a separate element.

The invention is based on the knowledge that the safety components are accommodated in one unit, as a result of which the outlay on servicing can be reduced. By accommodating all of the individual components in a common housing, it is additionally possible to considerably reduce the outlay on packaging during construction. The production process for the disconnection unit is considerably simplified when the fuse is integrated into the disconnection unit and does not first have to be connected to the disconnection unit separately. In addition, it is advantageous for it to be possible for all of the critical components to be readily replaced since the failure of the fuse is caused by malfunctioning of the contactors. Furthermore, the two connection points for the fuse are no longer required in the cable harness since they are integrated into the disconnection unit. The disconnection unit can advantageously be produced in greater numbers since it is a standardized component.

Furthermore, replacement of the safety components at zero voltage by replacing the disconnection unit can be simplified or ensured.

According to a preferred embodiment of the invention, provision is made for the fuse of the disconnection unit to produce the electrical contact connection by means of an interlocking and/or cohesive connection. In a further preferred embodiment of the invention, provision is made for the interlocking connection to be produced, preferably, by screws, and for the cohesive connection to correspond, preferably, to soldering. A reliable connection is advantageously permanently achieved with both types of connection.

According to a further preferred embodiment of the invention, provision is made for the disconnection unit to comprise at least one contactor which is connected to the fuse. This advantageously ensures that the battery is disconnected from the power system.

In a further preferred embodiment of the invention, provision is made for the contactor to be connected in series with the fuse. In this case, it is advantageous for the contactor or the fuse to be able to disconnect the battery from the power system and, at a current greater than the maximum disconnection current of the contactor, for the fuse to disconnect the battery from the power system up to a certain current, as a result of which very reliable disconnection is possible in spite of failure of the relay.

As an alternative, provision is advantageously made for the disconnection unit to have a current path containing sensors. The sensors are preferably current, temperature, voltage and/or insulation sensors. The advantage of a sensor is that measurement can be performed by it, for example the voltage is measured with the current sensor and the insulation is measured with the insulation sensor.

In a further preferred embodiment of the invention, provision is made for the fuse to preferably be a high-voltage fuse. On account of this special high-voltage fuse, it is advantageously possible to reliably disconnect the battery from the power system.

Provision is further made for the disconnection unit to have a large number of connection points, wherein current relays are incorporated into the connection between the respective connection points. As a result, it is advantageous for the respective current path to be able to be interrupted in a targeted manner.

According to an advantageous refinement of the invention, the battery is a lithium-ion battery. The use of lithium-ion technology means particularly high energy storage densities can be achieved, this leading to further advantages, particularly in the field of electromobility.

The invention additionally provides a motor vehicle having a battery, wherein the battery is connected to a drive system of the motor vehicle. The advantages of the disconnection unit according to the invention as a component therefore also benefit the motor vehicle as an assembly.

Advantageous developments of the invention are specified in the dependent claims and described in the description.

### DRAWINGS

Exemplary embodiments of the invention will be explained in greater detail with reference to the following description and the drawings, in which:

FIG. 1 shows a schematic illustration of a disconnection unit according to the invention with an integrated fuse, and

FIG. 2 shows a schematic illustration of a disconnection unit according to the invention.

### EMBODIMENTS OF THE INVENTION

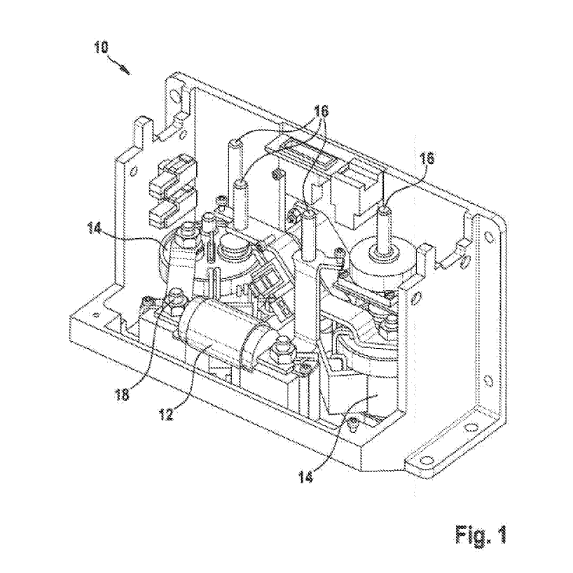

FIG. 1 shows an embodiment according to the invention of a disconnection unit 10. The disconnection unit 10 comprises at least four connection points 16 for various vehicle connections, such as a connection for charging a battery, connections for the vehicle drive or connections for connection to the battery cells for example. In this case, a distinction is drawn between the positive and negative connections of the battery cells and other high-voltage components, for example charging plug and inverter. Furthermore, FIG. 1 has at least two contactors 14 in order to switch the current.

Current relays are incorporated into the respective connection points 16 in order to be able to interrupt the respective current path in a targeted manner. In this case, the current relay is incorporated from a positive battery cell to a positive high-voltage component or from a negative battery cell to a negative high-voltage component. In addition, various sensors and a fuse 12 are integrated into the current path. Current sensors, voltage sensors, insulation sensors and temperature sensors are preferably used, wherein the voltage is measured with the current sensor and the insulation is measured with the insulation sensor. The fuse 12 is preferably a high-voltage fuse and is suitable for being connected in series with the contactors 14. In this case, the contactor 14 with the fuse 12 is designed for each current path. This produces an overlapping operating region between the fuse 12 and the contactors 14, that is to say only the contactors 14 disconnect the current between the battery and the power system up to a certain current. At precisely this current and above, the fuse 12 can also trip, in addition to the contactor 14. The fuse 12 then disconnects the battery from the power system at a current greater than the maximum disconnection current of the contactors 14. As a result, it is possible to reliably disconnect the electrical circuits, despite failure of the relay. It is clear that the fuse 12 is integrated into the disconnection unit 10 and is connected to the two contactors 14. Furthermore, the fuse 12 is preferably connected by screws 18.

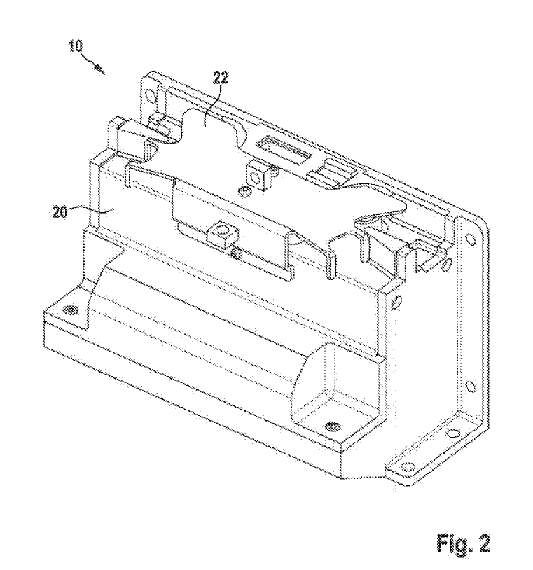

FIG. 2 shows a further embodiment of the disconnection unit 10. In this case, the disconnection unit 10 has a housing cover 20 and a cover 22 for the connection points 16. In this case, the components such as contactor 14 and fuse 12 are accommodated beneath the housing cover 20, and the connection points 16 are accommodated beneath the cover 22, and therefore cannot be seen in FIG. 2.

1. A disconnection unit for disconnecting a battery from a power system, the disconnection unit comprising:
a fuse integrated into the disconnection unit, the fuse configured to interrupt an electrical circuit between the battery and the power system.

2. The disconnection unit as claimed in claim 1, wherein the fuse has a permanent mechanical connection by at least one of an interlocking connection and a cohesive connection configured to produce the electrical contact connection.

3. The disconnection unit as claimed in claim 2, wherein the interlocking connection corresponds to a screw and the cohesive connection corresponds to soldering.

4. The disconnection unit as claimed in claim 1, further comprising at least one contactor which is connected to the fuse.

5. The disconnection unit as claimed in claim 4, wherein the contactor is connected in series with the fuse.

6. The disconnection unit as claimed in claim 1, wherein a current path has at least one of a current sensor, a temperature sensor, a voltage sensor, and an insulation sensor.

7. The disconnection unit as claimed in claim 1, wherein the fuse is a high-voltage fuse.

8. The disconnection unit as claimed in claim 1, further comprising:
a large number of connection points,
wherein current relays are incorporated into connections between respective connection points.

9. A battery, comprising:
a disconnection unit configured to disconnect a battery from a power system, the disconnection unit including a fuse integrated into the disconnection unit, the fuse configured to interrupt an electrical circuit between the battery and the power system.

10. A motor vehicle, comprising:
a battery, including a disconnection unit configured to disconnect a battery from a power system, the disconnection unit including:
a fuse integrated into the disconnection unit, the fuse configured to interrupt an electrical circuit between the battery and the power system, wherein the battery is connected to a drive system of the motor vehicle.

11. The battery as claimed in claim 9, wherein the battery is a lithium-ion battery.
